(19) United States
(12) Patent Application Publication
(10) Pub. No.: US 2006/0145973 A1
(43) Pub. Date: Jul. 6, 2006

(54) LCOS micro-display device

(76) Inventor: Haiming Jin, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,081

(22) Filed: Dec. 30, 2004

(51) Int. Cl. G09G 3/34

(52) U.S. Cl. 345/84

(57) ABSTRACT

Embodiments of the invention provide a digital micro-display device including two symmetric banks of pixel array blocks, which form the active display area, memory control and pixel look up tables (LUTs), and supporting data-paths and memory structures. Power straps are automatically generated. Initial power and ground pin locations are determined for each block. Locations are relocated based upon the actual placement and orientation of the placed blocks from which a set of strapping wires (lengths and widths) may be determined.

### RELATED APPLICATION

This application is related to U.S. application Ser. No. ______, entitled “LCOS Micro Display Driver Integrated Circuit,” filed on ______.

### BACKGROUND

Implementations of the claimed invention generally may relate to display devices and, more particularly, to LCOS micro display devices.

Liquid crystal on silicon (LCOS) devices, such as LCOS light modulators, are an important component of an optical projection system. LCOS devices, typically embodied in chips for use as “micro-display screens,” can eventually substitute for cathode ray tubes (CRTs) for a monitor or for a television. In particular, LCOS display devices include an array of display pixels fabricated on a silicon or other semiconductor substrate with associated control circuitry, and a quantity of liquid crystal material encapsulated overlying the display pixel array. When appropriate electrical signals are applied to the various pixels, they alter the transparency or polarization or reflectivity of the liquid crystal material which overlies their respective areas.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings

FIG. 1 illustrates an example system;

FIG. 2 illustrates an example connecting power and ground pins to an interface power strap;

FIG. 3 illustrates a flow chart illustrating an example of automatically generating power straps; and

FIGS. 4 (a)-(d) illustrate an example vector rotation matrix.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

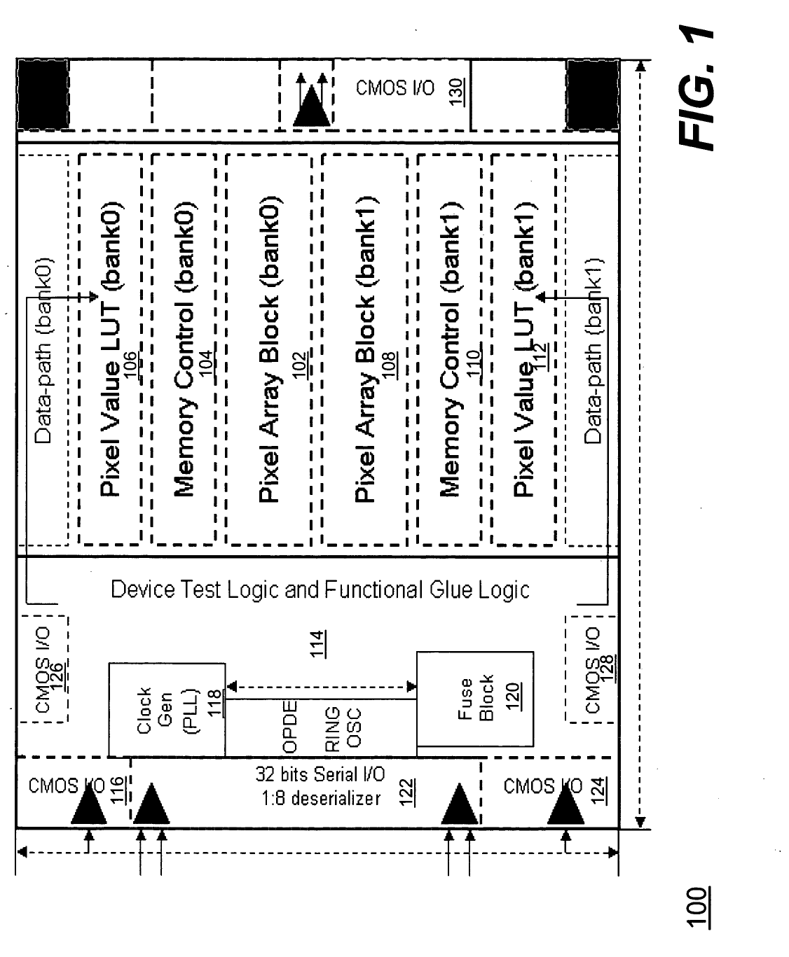

FIG. 1 illustrates an example system 100 of display device. Embodiments of the invention provide a digital micro-display device including two symmetric banks of pixel array blocks (PAB) 102 and 108, which form the active display area, memory control 104 and 110 and pixel look up tables (LUTs) 106 and 112, and supporting data-paths and memory structures. LCOS display devices include an array of display pixels fabricated on a silicon or other semiconductor substrate with associated control circuitry, and a quantity of liquid crystal material encapsulated overlying the display pixel array. When appropriate electrical signals are applied to the various pixels, they alter the transparency or polarization or reflectivity of the liquid crystal material which overlies their respective areas. Supporting data-paths and memory structures include test block 114, clock generator (for primary operating clocks) 118, fuse block 120 and I/O/deserializer 122. Additionally, I/O buffers 116, 124, 126, 128, and 130, which may be implemented as CMOS I/Os, handle input and output communications between the driver die and the outside world.

The display device floor plan of FIG. 1 shows some of the functional blocks of a single driver die. In a typical implementation, data is received through I/O/deserializer 122. I/O may be a 32 bit serial I/O in one implementation. Deserializer 122 may be 1:8 deserializer generating a 256 bit output. Output of deserializer 122 may be applied to test block 114 where for testing. Test block 114 may include an engine that generates a checkerboard pattern of 0s and 1s. In particular, it provides 256 bits of 0s and 256 bits of 1s in an alternating fashion to banks 0 and 1.

From test block 114, data may be applied to banks 0 and 1. Display device includes two banks of pixel array 102 and 108, two banks of memory controllers 104 and 110, and two banks of pixel value look up tables (LUTs) 106 and 112. Control logic directs which bank data is applied to. Data may be partitioned into two banks (bank 0 and bank 1) and correspondingly assembled. Banks 0 and 1 provide alternating usage. For example, bank 0 is filled first and then bank 1 and so forth. Data path illustrates data flow to each bank of pixel LUT, memory control and pixel array block.

Pixel array banks 0 and 1 contain an array of mirrors arranged in rows and columns for forming corresponding pixels of an image, and a liquid crystal for display functions of a LCOS device. One skilled in the art will recognize that arrangement of pixel array blocks and memory controls, pixel LUTs are not limited thereto. Other die arrangements may be available and more suitable for large-scale manufacture of LCOS devices if minimal silicon real estate is desired.

In a typical implementation, pixels are provided to data path in a serial fashion through bus having a 256-bit bus width. A picture is defined as a frame having a grid of a selected number of pixels. A “slice” is defined as a series of one or more groups of macroblocks aligned in horizontal rows within a frame. 194-bits are provided per slice. A 10 slice ripple provides for a 1940-bit line display (i.e. number of pixels in the x direction). The first 256 bits fills up a slice and then another 256 bits fills up another slice. The slices are filled row-wise. After a row is completed, a second row is filled in. 256-bits are provided on data paths for banks 0 and 1. The 256-bits are alternately provided to banks 0 and 1 when they come in.

Pixel value LUTs 106 and 112 assist in converting incoming signals for pixel array block. Signals that control the pixel gates get latched into memory control bank which controls the duration of how long the pixel gates will be on. In one implementation of the embodiment, a 1080 p micro-display on a 0.13 um technology with low power consumption may be provided.

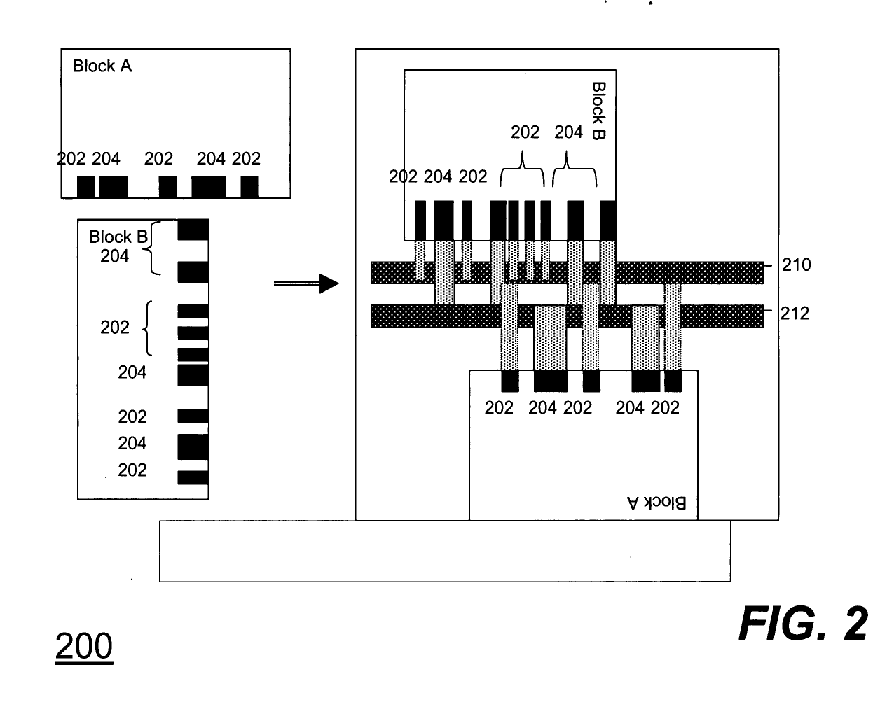

FIG. 2 illustrates an example 200 connecting power and ground pins to an interface power strap for display device 100 shown in FIG. 1. Power straps 202 and ground straps 204 that connect from interface power strap, including interface lines 210 or 212, to power pins 206 and ground pins 208 located at blocks 214 and 216 are automatically generated. Orientation and offset of the placed objects are recalculated as power and ground pin coordinates after blocks 214 and 216 are placed and sometimes rotated. Strap wire width 218 may be determined by the size of the power/ground, whereas strap wire length 220 may be the distance between the pin 206 or 208 and the target power/ground line 210 or 212.

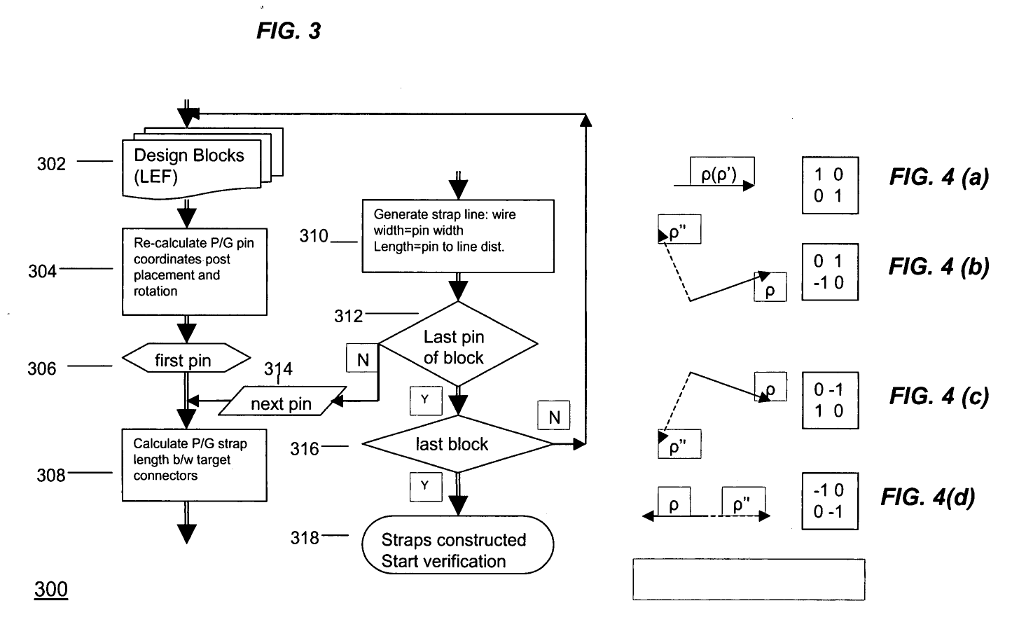

FIG. 3 illustrates a flow chart 300 illustrating an example process of automatically generating power straps. Although process 300 may be described with regard to FIG. 1 for ease of explanation, the claimed invention is not limited in this regard. For each block, initial power and ground pin locations are determined. For example, initial power and ground pin locations may be in the form of (x₀, y₀) and (x₁, y₁), where the former corresponds to the lower left corner of the pin and latter for the upper right corner. Locations are relocated based upon the actual placement and orientation of the placed blocks from which a set of strapping wires (lengths and widths) may be determined. New coordinates may be determined in accordance with the following equation:
(xᵢ′yᵢ′)=(xᵢ yᵢ)·ROT+(xₛ yₛ)
where ROT represents a rotation matrix such as that illustrated in FIGS. 4 (a)-(d), (xᵢ yᵢ) repreents the relative coordinate of one corner of the pin, and (xₛ yₛ) represents the placement offset of the block where the pin belongs. FIGS. 4 (a)-(d) illustrate an example vector rotation matrix 400. Referring to FIG. 4(a), no rotation is applied, resulting in no location change. Referring to FIG. 4(b), a 90 degree rotation may be applied. Each original single point is rotated by 90 degrees (0, 1, −1, 0) providing new coordinates. Referring to FIG. 4(c), a 270 or −90 degree rotation may be applied. Each original single point is rotated by 270 or −90 degrees (0, −1, 1, 0) providing new coordinates. Referring to FIG. 4(d), a 180 degree rotation may be applied. Each original single point is rotated by 180 degrees (−1, 0, 0, −1) providing new coordinates.

Referring to FIG. 3, in act 302, initial components of original power and ground pin coordinates are determined. For example, initial power and ground components such as their coordinate locations in a coordinate system are determined. In one implementation, this may be done according to a design block modeling technique such as LEF.

In act 304, the pin and ground pin coordinates post placement and rotation are recalculated. New “absolute” coordinates are determined in accordance with the following equation: (xᵢ′ yᵢ′)=(xᵢ yᵢ)·ROT+(xₛ yₛ) where ROT may be the rotation matrix illustrated in FIGS. 4(a)-(d).

For each power and ground pin (act 306), acts 308 to 310 are performed.

In act 308, the power and ground strap length between target connectors is calculated. As previously noted, referring to FIG. 2, strap length 220 may be the distance between the pin 206 or 208 and the target power/ground line 210 or 212.

In act 310, the strap line is generated. The width may be defined by the pin width and the length may be defined by the pin to line distance.

In act 312, it is determined whether the last pin of the block has been analyzed. If not, the next pin in the block is analyzed (act 314).

In act 316, it is determined whether the last block has been analyzed.

If not, the process returns to act 302. If the last block has been analyzed, straps are constructed (act 318).

Although systems are illustrated as including discrete components, these components may be implemented in hardware, software/firmware, or some combination thereof. When implemented in hardware, some components of systems may be combined in a certain chip or device.

Although several exemplary implementations have been discussed, the claimed invention should not be limited to those explicitly mentioned, but instead should encompass any device or interface including more than one processor capable of processing, transmitting, outputting, or storing information. Processes may be implemented, for example, in software that may be executed by processors or another portion of local system.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A display device comprising:
first and second banks, wherein each bank comprises:
a pixel array arranged comprising a plurality of pixels;
a pixel look up table to provide pixel values for incoming data; and
a memory control in communication with the pixel array, wherein the memory control controls transfer of future pixel values from memory to a pixel electrode in the pixel array.

2. The display device claimed in claim 1, wherein the pixel array comprises a reflective pixel array.

3. The display device claimed in claim 2, wherein the device comprises a liquid crystal on silicon display.

4. The display device claimed in claim 1, wherein incoming data is alternately provided to first and second banks.

5. The display device claimed in claim 4, wherein pixels are provided to data path in a serial fashion.

6. The display device claimed in claim 1, further comprising:
control device to automatically generate interface lines for connecting interface lines to power and ground pins.

7. The display device claimed in claim 6, wherein control device to automatically generate interface lines for connecting interface lines to power and ground pins further comprises:
control device to determine, for each power and ground pin, initial power and ground pin coordinates, recalculate pin and ground pin coordinates post placement and rotation, calculate power and ground strap length between target connectors and determining a strap length.

8. The display device claimed in claim 7, wherein the control device recalculate pin and ground pin coordinates in accordance with a rotation matrix.

9. The display device claimed in claim 7, wherein the control device recalculate pin and ground pin coordinates in accordance with (xᵢ′ yᵢ′)=(xᵢ yᵢ)·ROT+(xₛ yₛ) wherein ROT is a rotation matrix.

10. A method comprising:
determining power and ground pins associated with a board;
determining, for each power and ground pin, initial power and ground pin coordinates;
recalculating pin and ground pin coordinates post placement and rotation;
calculating power and ground strap length between target connectors; and
automatically generating interface lines for connecting interface lines to power.

11. The method claimed in claim 10, wherein recalculating pin and ground pin coordinates post placement and rotation further comprises:
recalculating pin and ground pin coordinates post placement and rotation in accordance with a rotation matrix.

12. The method claimed in claim 10, wherein recalculating pin and ground pin coordinates post placement and rotation further comprises:
recalculating pin and ground pin coordinates post placement and rotation in accordance with (xᵢ′ yᵢ′)=(xᵢ yᵢ)·ROT+(xₛ yₛ) wherein ROT is a rotation matrix.

13. The method claimed in claim 9, further comprising:
defining width by pin width and length by pin to line distance.

14. A system, comprising:
first and second banks, wherein each bank comprises:
a pixel array arranged comprising a plurality of pixels;
a pixel look up table to provide pixel values for incoming data;
a memory control in communication with the pixel array, wherein the memory control controls transfer of future pixel values from memory to a pixel electrode in the pixel array; and
a memory unit in communication with the memory control to store pixel data.

15. The system claimed in claim 14, wherein the pixel array comprises a reflective pixel array.

16. The system claimed in claim 14, wherein incoming data is alternately provided to first and second banks.

17. The system claimed in claim 14, further comprising:
control device to automatically generate interface lines for connecting interface lines to power and ground pins.

18. The system claimed in claim 17, wherein control device to automatically generate interface lines for connecting interface lines to power and ground pins further comprises:
control device to determine, for each power and ground pin, initial power and ground pin coordinates, recalculate pin and ground pin coordinates post placement and rotation, calculate power and ground strap length between target connectors and determining a strap length.

19. A machine-accessible medium including instructions that, when executed, cause a machine to:
determine power and ground pins associated with a board;
determine, for each power and ground pin, initial power and ground pin coordinates;
recalculate pin and ground pin coordinates post placement and rotation;
calculate power and ground strap length between target connectors; and
automatically generate interface lines for connecting interface lines to power.

20. The machine-accessible medium claimed in claim 19, wherein instructions to recalculate pin and ground pin coordinates post placement and rotation further comprises:
instructions to recalculate pin and ground pin coordinates post placement and rotation in accordance with a rotation matrix.
